(19) United States
(12) Patent Application Publication
(10) Pub. No.: US 2016/0061676 A1
(43) Pub. Date: Mar. 3, 2016

(54) Load Sensor for Tensioning Assembly

(71) Applicants: Raymond Brown, Modesto, CA (US); Manuel Lopez, Lodi, CA (US)

(72) Inventors: Raymond Brown, Modesto, CA (US); Manuel Lopez, Lodi, CA (US)

(73) Assignee: USA Products Group, Inc., Lodi, CA (US)

(21) Appl. No.: 14/468,515

(22) Filed: Aug. 26, 2014

(51) Int. Cl. G01L 5/00; G01L 1/20

(52) U.S. Cl. CPC G01L 5/0033; G01L 1/20

(57) ABSTRACT

A load sensor assembly integrally formed with a tensioning assembly or alternatively an inline load sensor assembly that is removably attachable to a line of a tensioning assembly to thereby provide for a relatively more reliable, efficient, and precise determination of a load, is disclosed herein.

### BACKGROUND

The present disclosure relates generally to a load sensor, and more particularly to a load sensor assembly integrally formed with a tensioning assembly or alternatively to an inline load sensor assembly that is removably attachable to a line of a tensioning assembly to thereby provide for a relatively more reliable, efficient, and precise determination of a load tension.

Modern tensioning assemblies, tie down, or pulley assemblies including ratchet buckles, turn buckles, cam buckles, over-center buckles, winches, and similar devices used to secure a load are usually of two types, specifically, cam buckle or ratching style technologies.

A typical ratchet assembly includes a rotatable hub with a plurality of outwardly-extending teeth for engagement with a spring-loaded pawl. A terminal end of the ratchet assembly is anchored to a first point. As the spool is rotated in one direction, a line, such as a flat webbing attached to a second point is wrapped around the hub to apply a tension to the line. As the hub rotates, the pawl incrementally engages the teeth to prevent the hub from rotating in the opposite direction due to the tension from the line.

Cam buckle assembly technology requires the same method of line installation as the ratcheting type device, but differs in that the cam buckle is depressed to open the teeth of the assembly while manual tension in applied to pull the webbing through the cam buckle. The webbing is typically held in place by a back pressure on the closed teeth of the cam buckle.

Although tensioning assemblies are well known and typically function well in securing loads, at times it may be desirable to know the amount of load tension applied to the line and therefore the load. In this regard, the shipping container or the cargo intended for storage or transport may be damaged if too much tension is applied. As such, determining the amount of load tension that is being applied by the tensioning assembly may be advantageous. In another instance, it may be desirable to be notified with a preset load tension is achieved. Accordingly, it would be desirable to provide to a load sensor, and more particularly a load sensor assembly integrally formed with a tensioning assembly or alternatively an inline load sensor assembly that is removably attachable to a line of a tensioning assembly to thereby provide for a relatively more reliable, efficient, and precise determination of a load tension.

### SUMMARY

For purposes of summarizing the disclosure, exemplary concepts have been described herein. It is to be understood that not necessarily all such concepts may be achieved in accordance with any particular embodiment. Thus, for example, those skilled in the art will recognize that embodiments may be carried out in a manner that achieves or optimizes one concept as taught herein without necessarily achieving other concepts as may be taught or suggested herein.

In one embodiment, a tensioning assembly comprising an integrally formed load sensor assembly for determination of a load tension, is disclosed herein.

In another embodiment, a removably attachable load sensor assembly comprising a frame structure: a first line connected to the frame structure; and a second line connected to a tensioning assembly, wherein connection of the first line and the second attaches the load sensor to the tensioning assembly to determine a load tension, is disclosed herein.

In still another embodiment, an inline load sensor assembly removably attachable to a line of a tensioning assembly to determine a load tension developed by the tensioning assembly, is disclosed herein.

These and other embodiments will become apparent to those skilled in the art from the following detailed description of the various embodiments having reference to the attached figures, the disclosure not being limited to any particular embodiment.

### BRIEF DESCRIPTION OF THE DRAWINGS

FIG. 1 shows an example of a known tensioning assembly.

FIG. 2 shows a tensioning assembly having an integrally formed load sensor assembly in accordance with one embodiment disclosed herein.

FIG. 3 is an enlarged view of the integrally formed load sensor assembly of the tensioning assembly of FIG. 2 in accordance with an embodiment disclosed herein.

FIG. 4 shows the general circuitry components or elements, and the signal or data flow between the circuitry elements and related components of the load sensor assembly of FIG. 2 in accordance with an embodiment disclosed herein.

FIG. 5 shows a load sensor assembly that is removably attachable to a line of a tensioning assembly in accordance with an embodiment disclosed herein.

FIG. 6 shows an expanded view of various parts of the removably attachable load sensor assembly of FIG. 5 disclosed herein.

FIG. 7 shows the removably attachable load sensor assembly of FIG. 5 in a non-tensioned state in accordance with an embodiment disclosed herein.

FIG. 8 show the removably attachable load sensor assembly of FIG. 5 in a tensioned state in accordance with an embodiment disclosed herein.

FIG. 9 shows another view of the removably attachable load sensor assembly of FIG. 5 in accordance with an embodiment disclosed herein.

FIG. 10 shows an inline load sensor assembly that is removably attachable to a line of a tensioning assembly in accordance with an embodiment disclosed herein.

FIG. 11 shows the inline load sensor assembly of FIG. 10 in a see-through perspective in accordance with an embodiment disclosed herein.

FIG. 12 shows an expanded view of various parts of the inline load sensor assembly of FIGS. 10 and 11 disclosed herein.

FIGS. 13 and 14 show the inline load sensor assembly of FIG. 10 in a non-tensioned state in accordance with an embodiment disclosed herein.

FIGS. 15 and 16 show the inline load sensor assembly of FIG. 10 in a tensioned state in accordance with an embodiment disclosed herein.

FIG. 17 shows another inline load sensor assembly that is removably attachable to a line of a tensioning assembly in accordance with an embodiment disclosed herein.

FIG. 18 shows the inline load sensor assembly of FIG. 17 in a non-tensioned state in accordance with an embodiment disclosed herein.

FIG. 19 shows the inline load sensor assembly of FIG. 17 in a tensioned state in accordance with an embodiment disclosed herein.

FIG. 20 shows the general circuitry components or elements, and the signal or data flow between the circuitry elements and related components of the inline load sensor assembly of FIG. 17 in accordance with an embodiment disclosed herein.

### DETAILED DESCRIPTION

Exemplary embodiments will now be described with references to the accompanying figures, wherein like reference numbers refer to like elements throughout. The terminology used in the description presented herein in not intended to be interpreted in any limited or restrictive manner simply because it is being utilized in conjunction with a detailed description of certain embodiments. Furthermore, various embodiments (whether or not specifically described herein) may include novel features, no single one of which is solely responsible for its desirable attributes or which is essential to practicing any of the embodiments herein described.

The present disclosure relates generally to a load sensor, and more particularly to a load sensor assembly integrally formed with a tensioning assembly or alternatively to an inline load sensor that is removably attachable to a line of a tensioning assembly to thereby provide for a relatively more efficient and precise determination of a load tension.

As used herein, the term “line” is intended to include a rope (round synthetic, natural fiber, metal), a cable, a cord, a flat line (webbing), an anchor line or tensioning line, or a similar type of article(s) that may be adapted to be used with the sensor assembly or tensioning assembly disclosed herein for the purpose of applying tension to secure a “load”.

As used herein, the term“load” or “cargo” is intended to include any item or items that are generally secured to prevent movement of the item(s) while in a static position, or while being moved or transport from one position to another position.

As used herein, the term tensioning assembly is intended to include any device capable of applying a tension to a line to secure a load. Such tensioning devices include, but are not limited to ratchet buckles, turn-buckles, cam buckles, over-center buckles, winches, and similar devices.

Various parts, elements, components, etc, of the various load sensor assemblies disclosed herein may be constructed from metal, plastic, composite, or other suitable material or combination thereof for providing a rigid and sturdy structure to facilitate a reliable, efficient, and precise determination of a tension by the load sensor assembly.

The actual size, dimension, and position of any and all of the various parts, elements, components, etc., of the load sensor may vary depending on various factors including, among other things, intending application or usage of the load sensor assembly, as well as the size of the line utilized in conjunction with the load sensor assembly.

Connection(s) between the various parts, elements, components, etc., of the load sensor assembly may be accomplished using a variety of methods or processes. As such, the connections, whether integral and created via bending, or form molding, for example, or connected via bonding, hardware (nuts, bolts, washers, etc.), welding, or similar techniques, are well known in the art and omitted for simplicity.

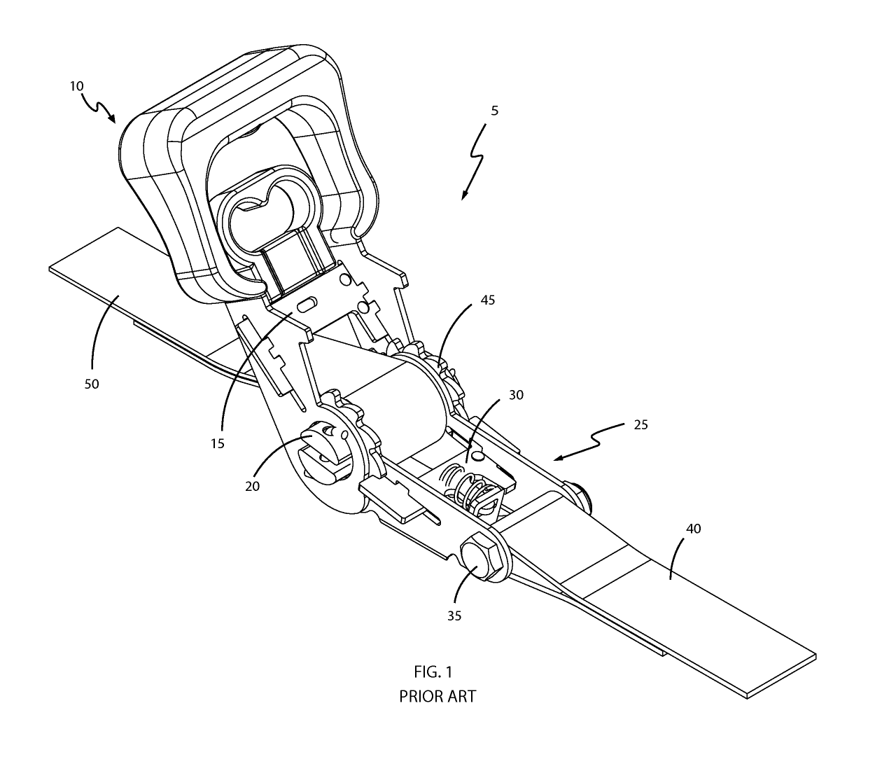

FIG. 1 shows one example of a known tensioning assembly 5 for applying a tension, i.e., load tension, to a load (not shown). The ratchet type tensioning assembly 5 shown in FIG. 1 is used for illustrative purposes and those skilled in the art will understand that other types of tensioning assemblies or devices including, but not limited to ratchet buckles, turn buckles, cam buckles, over-center buckles, winches, and similar devices may be utilized in view of the load sensor assembly and teachings disclosed herein.

In very general terms, the tensioning assembly 5 of FIG. 1 includes an upper frame assembly 10 configured to receive an upper drive pawl 15 and a hub or spindle 20 therebetween. The tensioning assembly 5 further includes a lower frame assembly 25 rotatably connected to the upper frame assembly 10 and configured to receive a lower pawl 30 and a connection member or anchor post 35 therebetween. The connection member 35 may be a bolt and nut combination or a similar device for support and stability of the tensioning assembly 5, and for attaching or connecting a first line 40, for example a flat-webbing, to the tensioning assembly 5 at one end and at a second end to an anchor point. The hub 20 includes a plurality of outwardly-extending teeth 45 for engagement with the upper and lower pawls 15, 30. As the upper frame assembly 10 is rotated in one direction, a second line 50, similar to the first line 40, attached or connected to a second anchor point is wrapped around the hub 20 to apply a tension to each of the first line 40 and the second line 50. As the hub 20 rotates, the lower pawl 30 incrementally engages the teeth 45 to prevent the hub 20 from rotating in the opposite direction due to the tension applied to the first line 40 and the second line 50.

As indicated previously, although tensioning assemblies such as the one shown in FIG. 1 are well known and typically function well in securing loads, at times it may be desirable to be informed of the amount of load tension being applied to the load. In this regard, a shipping container or the cargo being secured may be damaged if too much tension is applied. As such, determining the amount of load tension that is being applied by the tensioning assembly may be advantageous.

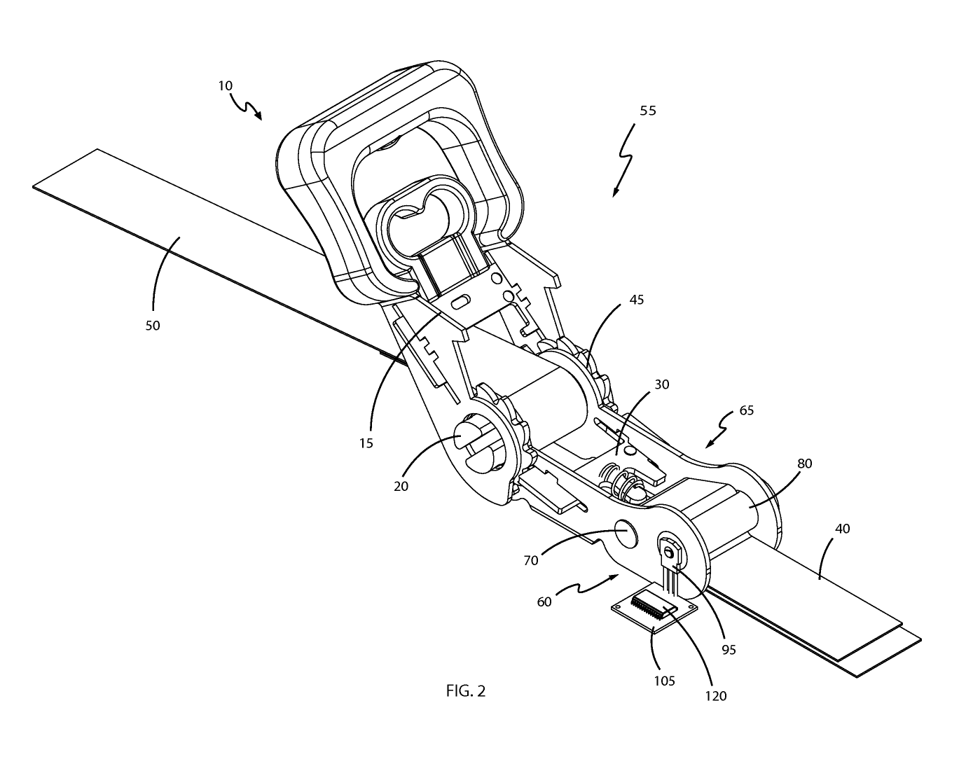

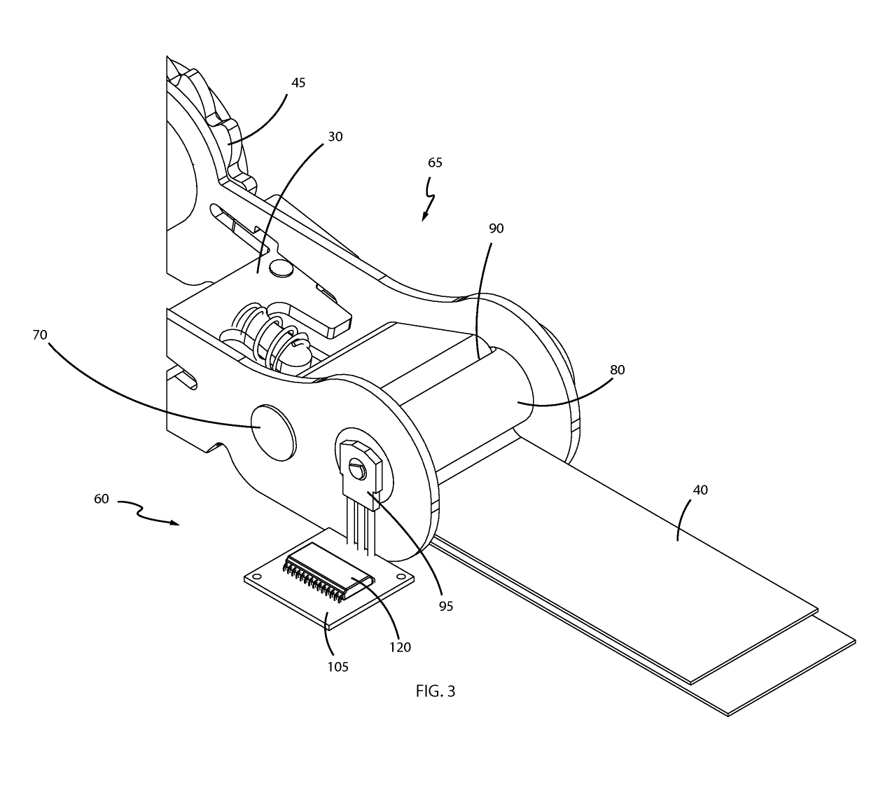

FIG. 2 shows a tensioning assembly 55 having an integrally formed load sensor assembly 60 in accordance with an embodiment disclosed herein, and FIG. 3 is an enlarged view of the integrally formed load sensor assembly 60 of the tensioning assembly 55 of FIG. 2.

In this regard, the tensioning assembly 55 includes an upper frame assembly 10 configured to receive an upper drive pawl 15 and a hub or spindle 20 therebetween. As indicated previously, the upper frame assembly 10 is only used for illustrative purposes and those skilled in the art will understand that other configurations of tensioning assemblies or devices may be utilized in connection with the integrally formed load sensor assembly 60 disclosed herein and shown in FIG. 2.

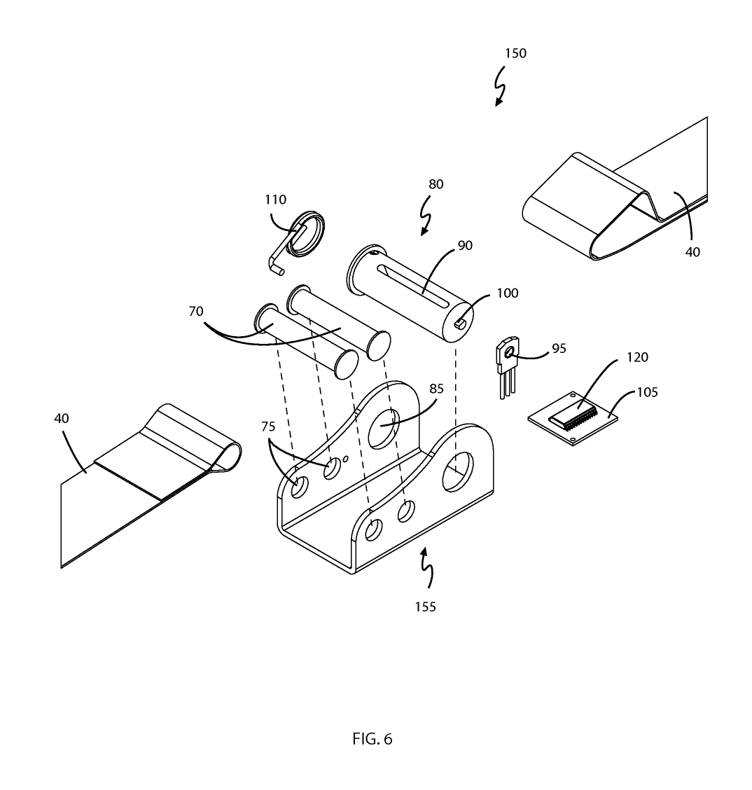

The tensioning assembly 55 further includes a lower frame assembly 65 rotatably connected to the upper frame assembly 10 and configured to receive a lower pawl 30 and include the integrally formed load sensor assembly 60. The integrally formed load sensor assembly 60 includes a post, bolt, or similar cylindrical structure 70 received into a corresponding orifice 75 (FIG. 6) formed in the lower frame assembly 65, and a rotatable spindle 80 received into a corresponding orifice 85 (FIG. 6) of the lower frame assembly 65. The rotatable spindle 80 is held in place by a spring 110, shown in FIG. 6.

The rotatable spindle 80 includes a slot, slit, or opening 90 formed therein for receiving a line such as the first line 40 shown in FIG. 1. In this regard, as shown in FIG. 7, the first line 40 is disposed around the post 70, passed through the slot 90 in the spindle 80, and attached or connected together by sewing or other means as the first line 40 exits from the lower frame assembly 65. During use of the tensioning assembly 55 the first line 40 is typically attached or connected to an anchor point.

The integrally formed load sensor assembly 60 further includes a sensor pot 95 such as a potentiometer, variable resistor, or similar device connected to the rotatable spindle 80. Connection of the sensor pot 95 to the rotatable spindle 80 is facilitated by the rotatable spindle 80 having an end 100 correspondingly shaped to match an opening formed in the sensor pot 95. Accordingly, as a load tension is applied to the line 40, the spindle 80 rotates, and the sensor pot 95 correspondingly rotates and detects the degree of rotation of the spindle 80. The degree of rotation of the spindle 80 indicates the amount of tension placed on the line 40 and a corresponding tension placed on a load (load tension). A printed circuit board (PCB) 105 including a processor 120 disposed thereon and other related components are electrically connected to the sensor pot 95 via wires 115 to receive information related to the detected degree of rotation of the spindle 80.

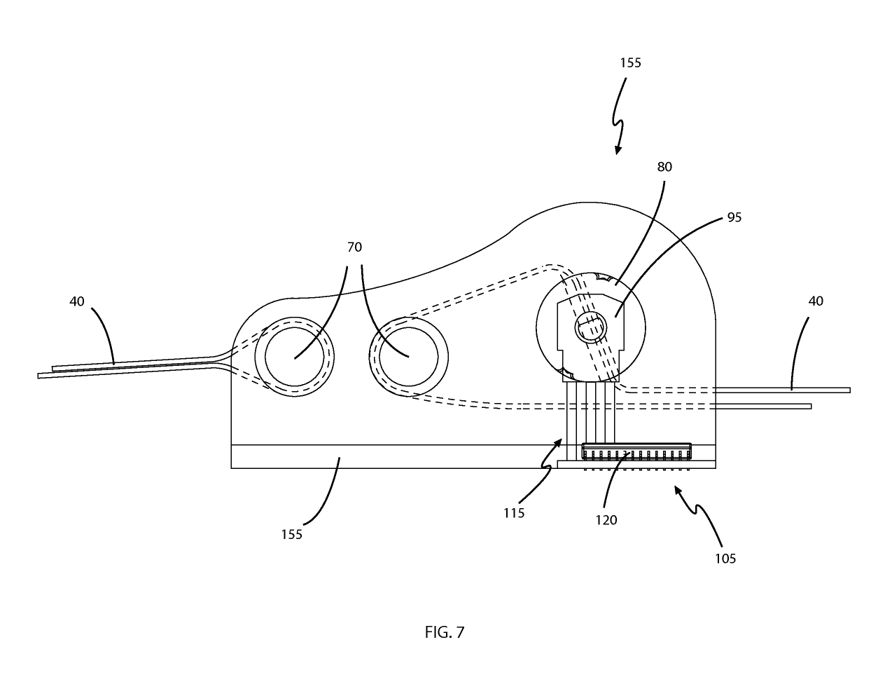

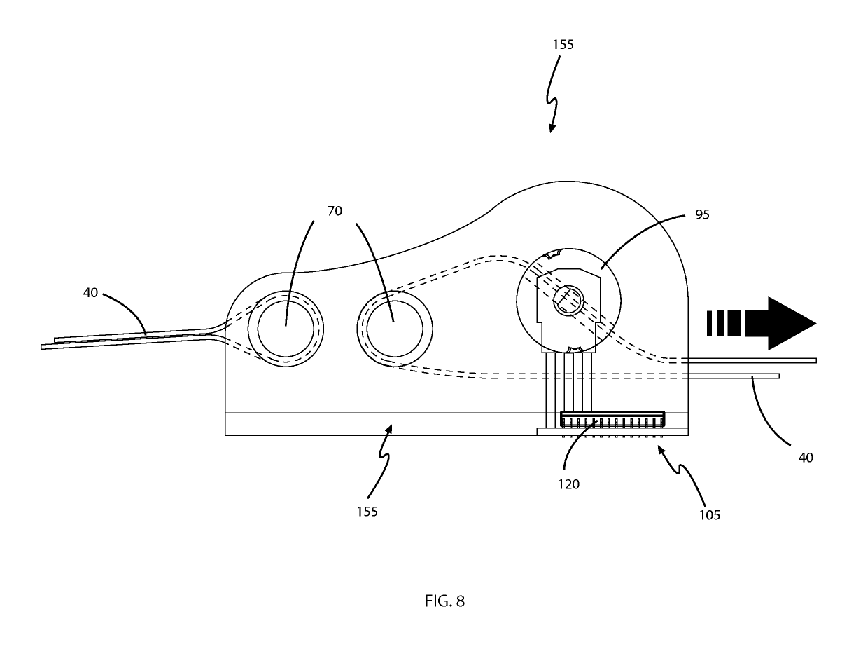

A comparison between FIG. 7 and FIG. 8, shows a difference in positioning of the sensor pot 95 and the tension in the line 40 in a non-tensioned state (FIG. 7), and the rotation of the sensor pot 95 and tensioning of the line 40 in a tensioned state (FIG. 8) as tension is applied to the line 40 in the direction shown by the arrow. In this regard, the load sensor assembly 60 is configured to determine a load tension by converting the incremental mechanical rotational movement of the spindle 80 into an electrical signal representative of the load tension incrementally from zero pounds to many thousand pounds in a reliable, efficient, and precise manner.

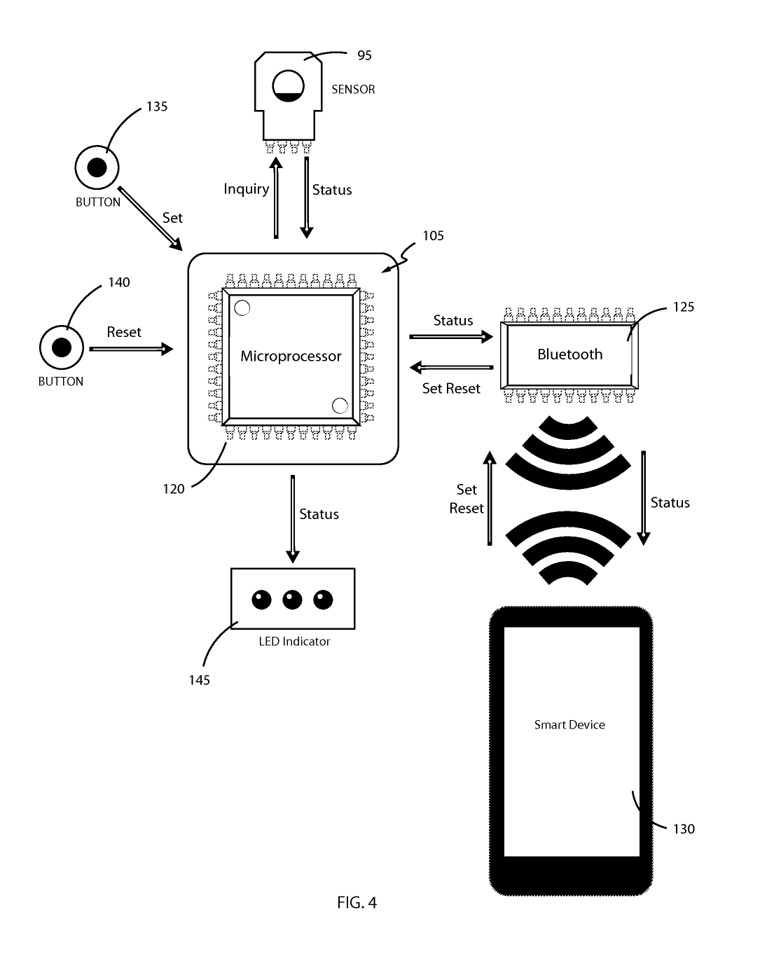

FIG. 4 shows the general circuitry components or elements, and the signal or data flow between the circuitry elements or related components in accordance with an embodiment of the integrally formed load sensor assembly disclosed herein. As shown in FIG. 4, the general circuitry components of the load sensor assembly 60 and signal flow between related components includes the sensor pot 95, PCB 105, and processor 120, as well as a bluetooth component 125 for wireless communication with a smart device 130 such as a tablet, phone, PDA, or similar device. As such, the integrally formed load sensor 60 includes wireless capability for communication of the determination of the load tension to another wireless device.

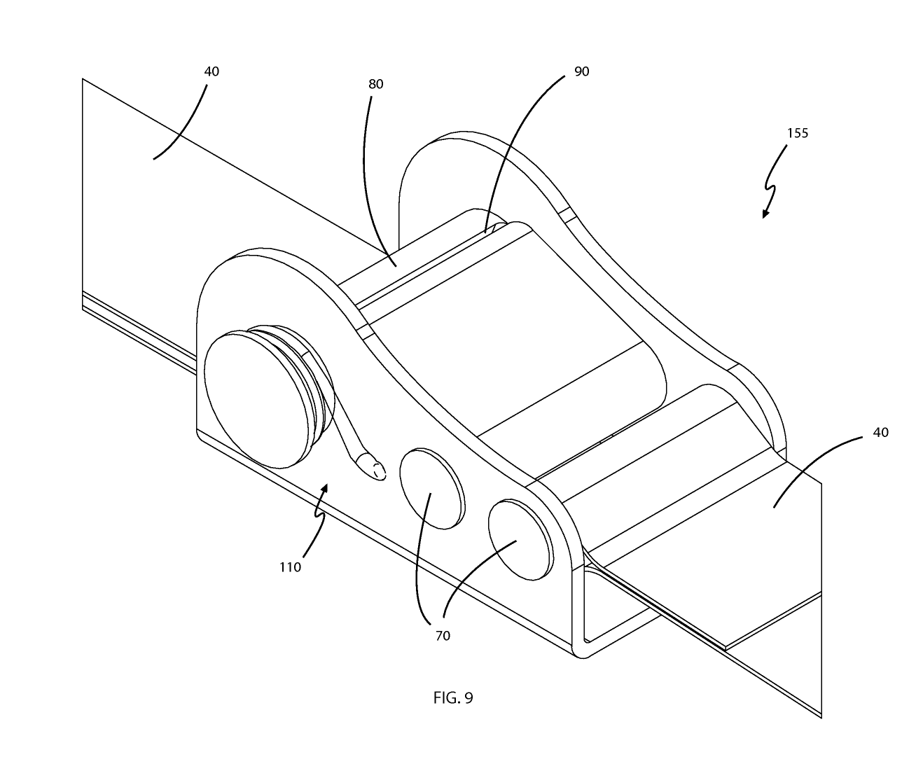

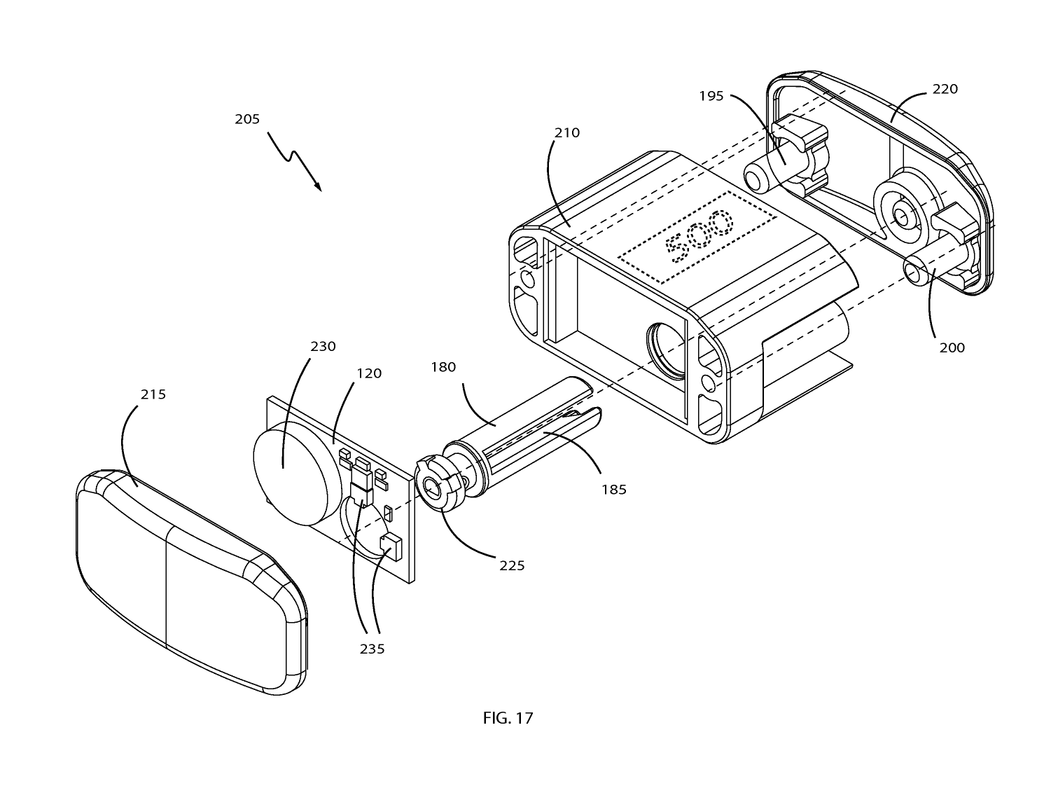

The load sensor assembly 60 may further include a battery or power source (not shown) to power the circuit components, a set button 135 and a reset button 140 for activation of the load sensor assembly 60 and reset of the load sensor assembly 60 after detection of a tension on a load. The load sensor assembly 60 may further include a status indicator 145 such as an indicator light (LED) or audible indicator to indicate that the load sensor assembly 60 is activated, reached a preset load tension limit, determined an incremental load tension, or a loss of a load tension. Likewise, indication of the status of the load sensor assembly 60 as well as a visual representation including a digital or a pictorial representation of the load tension determined by the load sensor assembly 60 may be presented on the smart device 140. Alternatively, as shown at least in FIGS. 10 and 17, and understood to apply as well to all the embodiments disclosed herein, the status of the load tension may be display on the load sensor 60, 160, 150, 205.

Accordingly, similar to the tensioning device shown in FIG. 1, as the upper frame assembly 10 of the tensioning assembly shown in FIG. 2 is rotated in one direction, the second line 50 attached or connected to a second anchor point is wrapped around the hub 20 to apply a tension to each of the first line 40 and the second line 50. The lower pawl 30 incrementally engages the teeth 45 to prevent the hub 20 from rotating in the opposite direction due to the tension applied to the first line 40 and the second line 50. As the hub 20 rotates, the tension applied to the first line 40 is incrementally determined by the load sensor assembly 60. The determined load tension may then be wirelessly communicated to the smart device 130.

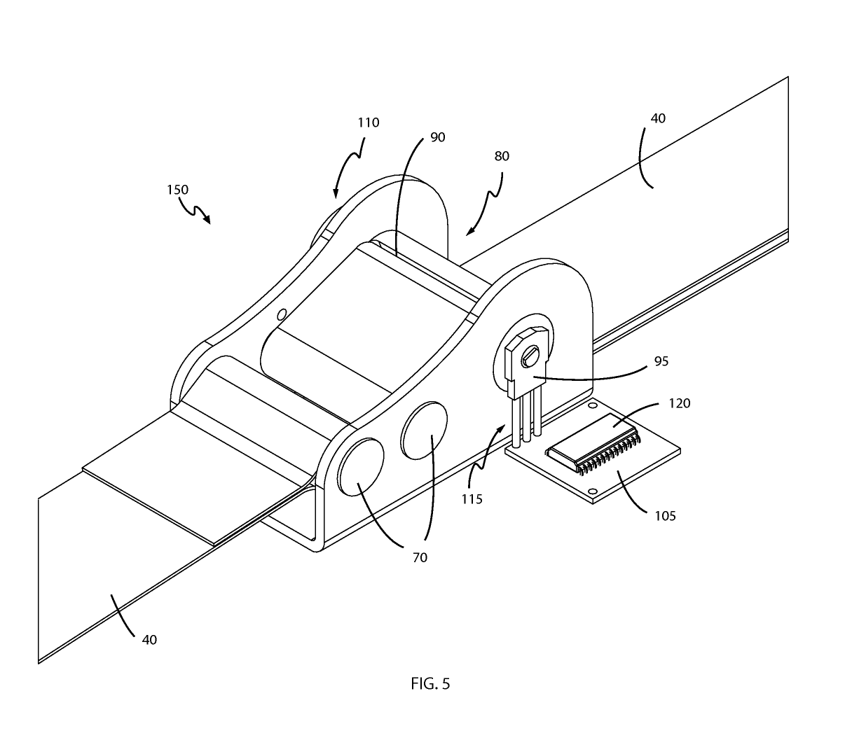

FIG. 5 shows a load sensor assembly that is removably attachable to a line of a tensioning assembly in accordance with another embodiment disclosed herein, and FIG. 6 shows an expanded view of various parts of the removably attachable load sensor assembly of FIG. 5 disclosed herein.

In this regard, the load sensor assembly 150 includes a base or frame structure 155. The load sensor assembly 60 includes two posts 70, a first inside post and a second outside post, each received into a corresponding orifice 75 formed in the frame 155, and a rotatable spindle 80 received into a corresponding orifice 85 of the frame structure 155. The rotatable spindle 80 is held in place by a spring 110. Persons of ordinary skill in the art will understand that bolts, or similar cylindrical structures may be used in place of the posts 70.

The rotatable spindle 80 includes a slot, slit, or opening 90 formed therein for receiving a first line 40. In this regard, as shown in FIG. 7, the first line 40 is disposed around the inside post 70, passed through the slit 90 in the spindle 80, and attached or connected together by sewing or other means as the first line 40 exits from the frame structure 155. A second line 40, similar to the first line 40 is attached or connected to the outside post 70 by sewing together or other means the first line 40 to form a loop around the outside post 70. Each of the first and second lines 40 may be terminated with a loop, hook, clamp, or similar type device for attaching or connecting one of the first line or second line to an anchor point and the other of the first line or the second line to a tensioning assembly, such as the one shown in FIG. 1, for applying a tension, i.e., load tension, to a load (not shown).

The tensioning assembly shown in FIG. 1 is used for illustrative purposes and those skilled in the art will understand that other types of tensioning devices including, but not limited to ratchet buckles, turn buckles, cam buckles, over-center buckles, winches, and similar devices may be utilized in view of the load sensor assembly 150 and teachings disclosed herein. As such, the load sensor assembly 150 is removably attachable to a line of a tensioning assembly. In this manner, the removable attachable load sensor assembly 150 allows for efficient attachment and removal of the load sensor assembly 150 to an existing tensioning assembly when the determination of a load tension is desirable.

The load sensor assembly 150 further includes a sensor pot 95 such as a potentiometer, variable resistor, or similar device connected to the rotatable spindle 80. Connection of the sensor pot 95 to the rotatable spindle 80 is facilitated by the rotatable spindle 80 having an end 100 correspondingly shaped to match an opening formed in the sensor pot 95. Accordingly, as a load tension is applied to the line 40, the spindle 80 rotates, and the sensor pot 95 correspondingly rotates and detects the degree of rotation of the spindle 80. The degree of rotation of the spindle 80 indicates the amount of tension placed on the line 40 and a corresponding tension placed on a load (load tension). A printed circuit board (PCB) 105 including a processor 120 disposed thereon and other related components including a battery or similar power source are electrically connected to the sensor pot 95 via wires 115 to receive information related to the detected degree of rotation of the spindle 80.

The functionality of the sensor pot 95 and associated circuitry (FIG. 4) of the load sensor assembly 150 of FIG. 5 is essentially the same as disclosed for the integrally formed load sensor assembly 60 of FIG. 2. As indicated previously, a comparison between FIG. 7 and FIG. 8, shows a difference in positioning of the sensor pot 95 and the tension in the line 40 in a non-tensioned state (FIG. 7), and the rotation of the sensor pot 95 and tensioning of the line 40 in a tensioned state (FIG. 8) as tension is applied to the line 40 in the direction shown by the arrow. In this regard, the load sensor assembly 155 is configured to determine a load tension by converting the incremental mechanical rotational movement of the spindle 80 into an electrical signal representative of the load tension incrementally from zero pounds to many thousand pounds in a reliable, efficient, and precise manner.

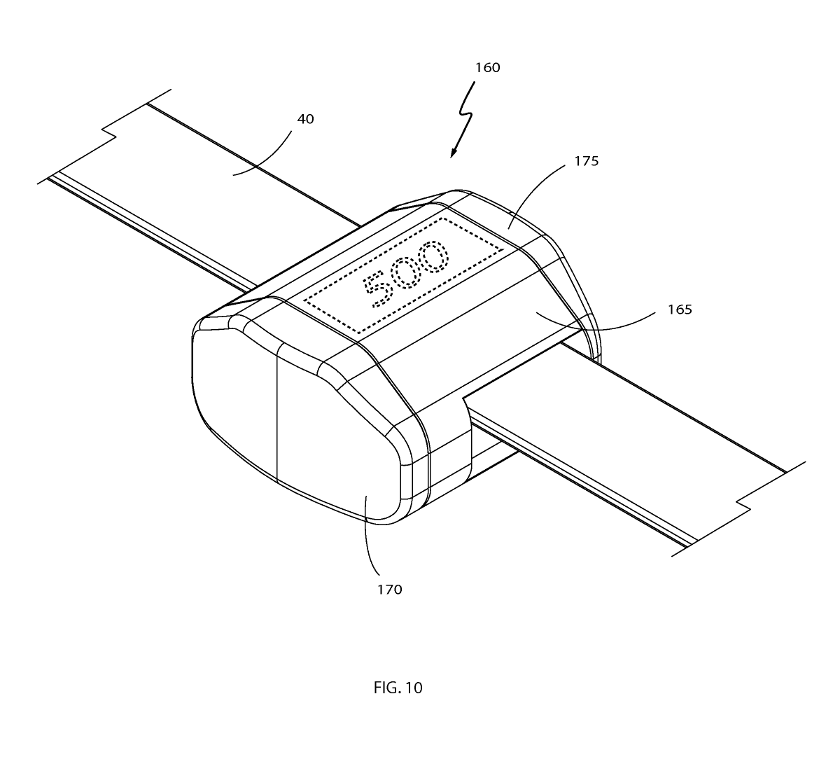

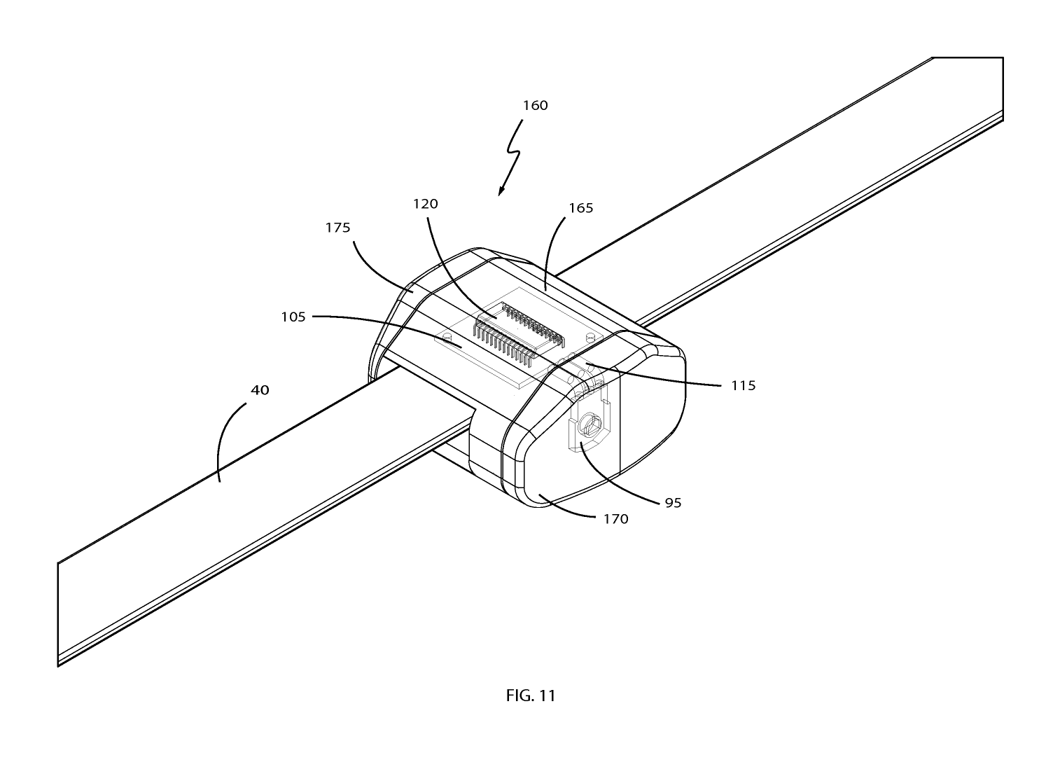

FIG. 10 shows an inline load sensor assembly that is removably attachable to a line of a tensioning assembly in accordance with an embodiment disclosed herein, FIG. 11 shows the inline load sensor assembly of FIG. 10 in a see-through perspective, and FIG. 12 shows an expanded view of various parts of the inline load sensor assembly of FIG. 10 disclosed herein.

In this regard, the inline load sensor assembly 160 includes a main body 165 and corresponding side bodies 170, 175 that fit together either in a press fit, snap fit, or similar means to allow access to the inside of the inline load sensor assembly 160 to facilitate removable attachment of the inline load sensor assembly 160 onto a line 40 of a tensioning assembly such as the tension assembly shown in FIG. 1. In this regard, the line 40 is accepted or otherwise received into the inline load assembly 160. As shown in FIG. 12, the inline load sensor assembly 160 further includes a rotatable spindle 180 having a slot, slit, or opening 185 formed therein for receiving the line 40.

Similar to the integral load sensor assembly 60 of FIG. 2 and the removable attachable load sensor assembly 150 of FIG. 5, the inline load sensor assembly 160 shown in FIG. 12 further includes a sensor pot 95 such as a potentiometer, variable resistor, or similar device connected to the rotatable spindle 180. Connection of the sensor pot 95 to the rotatable spindle 180 is facilitated by the rotatable spindle 180 having an end 100 correspondingly shaped to match an opening formed in the sensor pot 95. Accordingly, as a load tension is applied to the line 40, the spindle 180 rotates, and the sensor pot 95 correspondingly rotates and detects the degree of rotation of the spindle 180. The degree of rotation of the spindle 180 indicates the amount of tension placed on the line 40 and a corresponding tension placed on a load (load tension). As such, the inline load sensor assembly 160 is removably attachable to a line 40 of a tensioning assembly to determine a load tension developed by the tensioning assembly. A printed circuit board (PCB) 105 including a processor 120 disposed thereon and other related components are electrically connected to the sensor pot 95 via wires 115 to receive information related to the detected degree of rotation of the spindle 180. A spring 190 is included to hold the rotatable spindle 180 in place inside the main body 165.

One of the side bodies 175 may include guide posts 195, 200 to assist in guiding the side body 175 back into the main body 165 after removal of the side body 175 from the main body 165 to permit the line 40 of the tensioning assembly 5 to be inserted (received, accepted, etc.) into the slot 185 of the rotatable spindle 180.

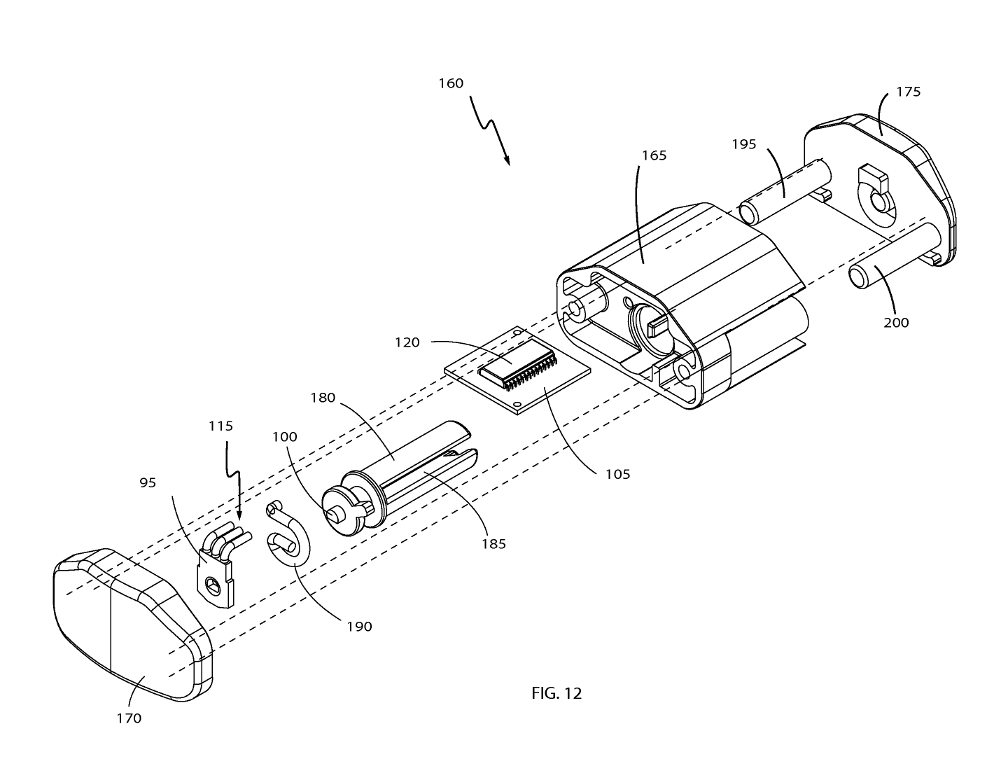

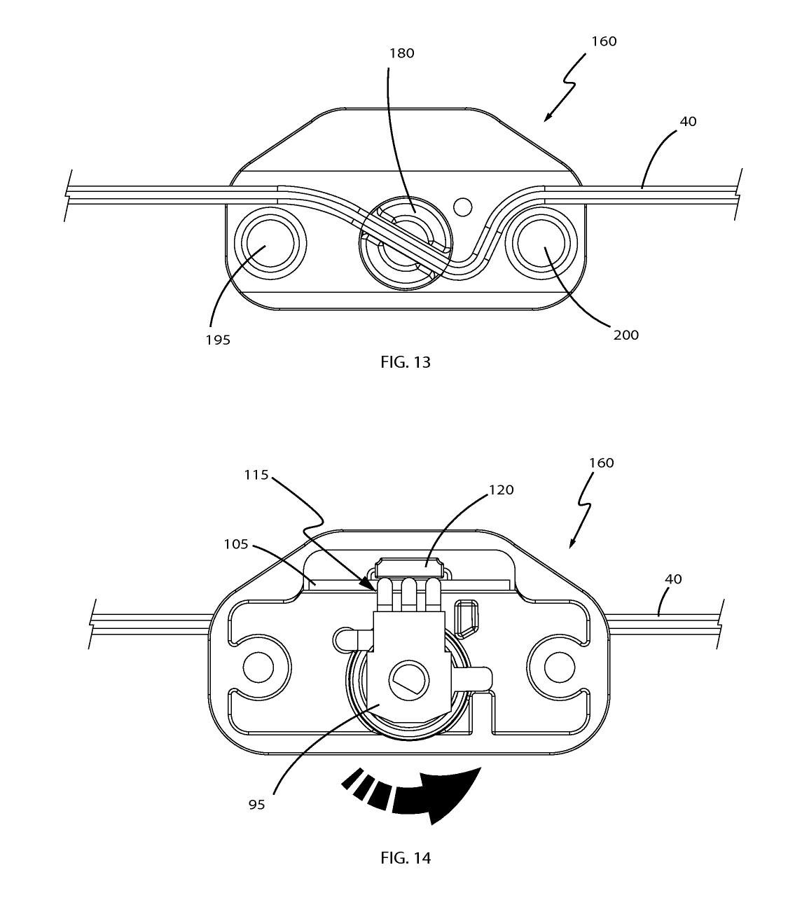

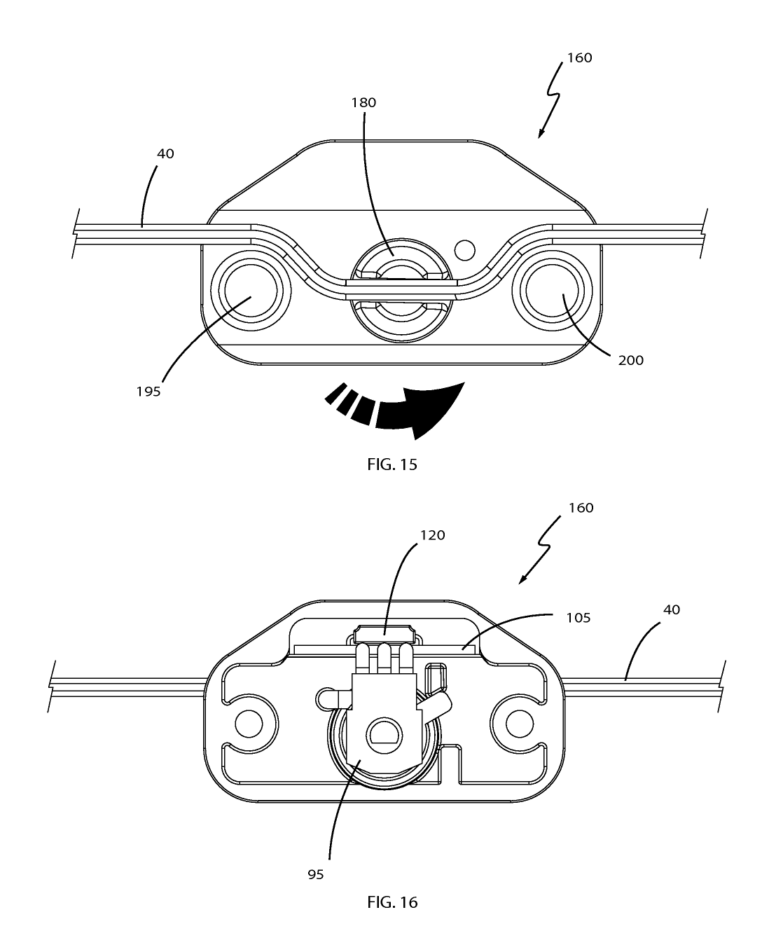

A comparison between FIGS. 13 and 14, and FIGS. 15 and 16 show a difference in positioning of the sensor pot 95 and the tension in the line 40 in a non-tensioned state (FIGS. 13 and 14), and the rotation of the sensor pot 95 and tensioning of the line 40 in a tensioned state (FIGS. 15 and 16) as tension is applied to the line 40 in the direction shown by the arrow. In this regard, when the line 40 inserted into the inline load sensor assembly 160 is tensioned and the spindle 180 is rotated. The inline load sensor 160 is configured to determine a load tension by converting the incremental mechanical rotational movement of the spindle 180 into an electrical signal representative of the load tension incrementally from zero pounds to many thousand pounds in a reliable, efficient, and precise manner.

The general circuitry components of the inline load sensor assembly 160 and signal flow between related components is similar to that shown in FIG. 4. In this regard, the inline load sensor 160 includes the sensor pot 95, PCB 105, and processor 120, as well as a bluetooth component 125 for wireless communication with a smart device130 such as a tablet, phone, PDA, or similar device. The inline load sensor assembly 160 may further include a battery (not shown) or other power source, and a set button 135 and a reset button 140 for activation of the inline load sensor assembly 160 and reset of the inline load sensor assembly 160 after detection of a tension on a load. The inline load sensor assembly 160 may further include a status indicator 145 such as an indicator light (LED) or audible indicator to indicate that the inline load sensor assembly 160 is activated, reached a preset load tension limit, determined an incremental load tension, or a loss of a load tension. Likewise, indication of the status of the inline load sensor assembly 160 as well as a visual representation including a digital or a pictorial representation of the load tension determined by the inline load sensor assembly 160 may be presented on the smart device 140.

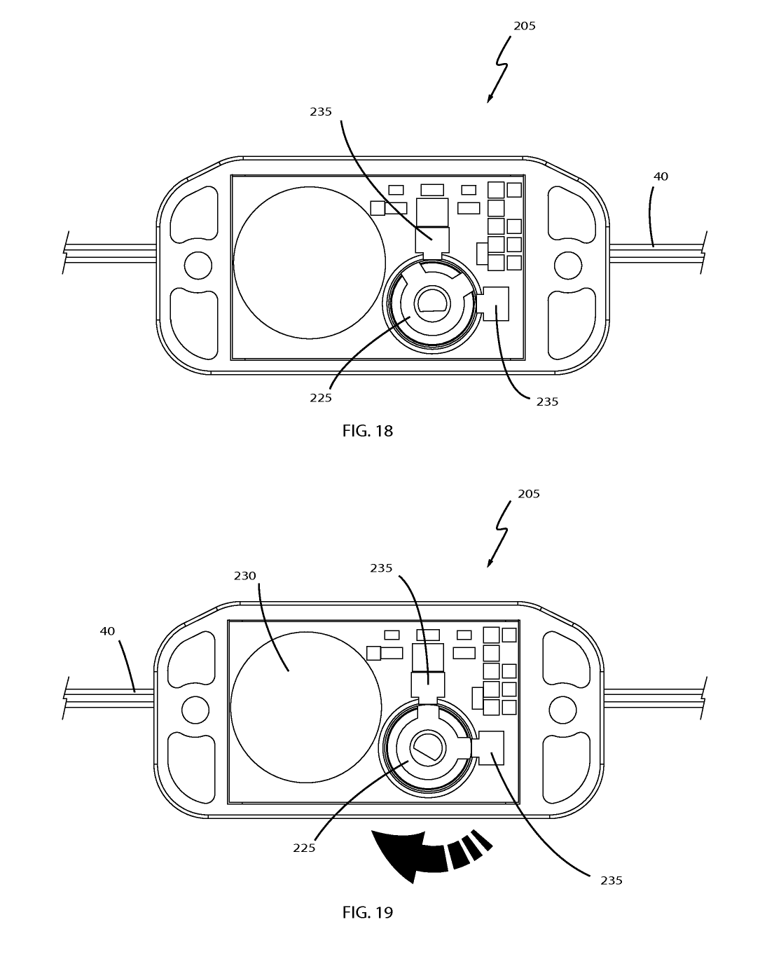

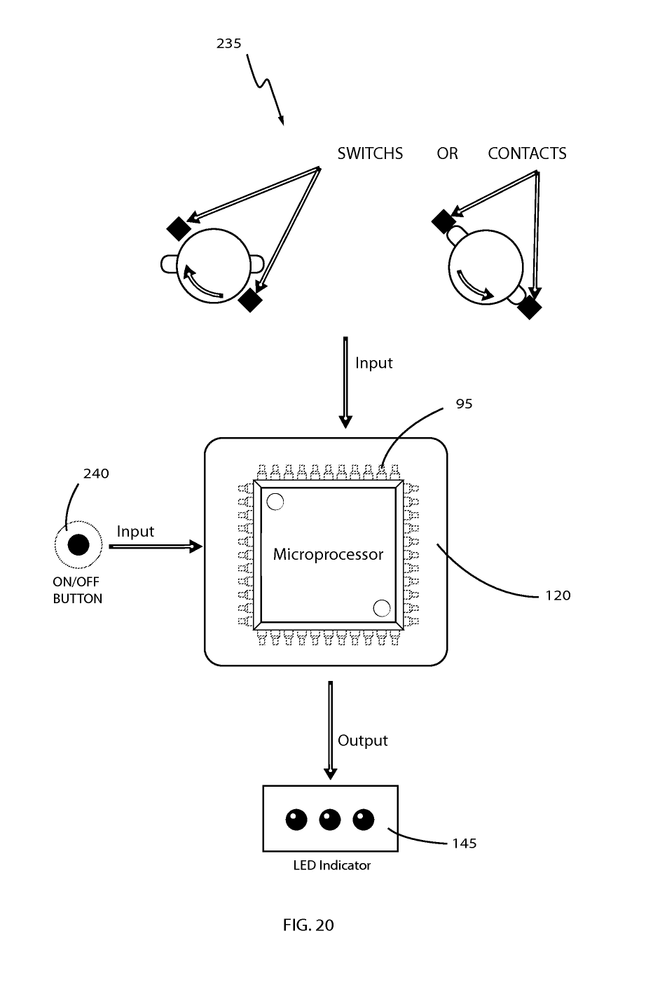

FIG. 17 shows another inline load sensor assembly that is removably attachable to a line of a tensioning assembly in accordance with an embodiment disclosed herein, FIG. 18 shows the inline load sensor assembly of FIG. 17 in a non-tensioned state, FIG. 19 shows the inline load sensor assembly of FIG. 17 in a tensioned state, and FIG. 20 generally shows the circuitry components or elements, and the signal or data flow between the circuitry elements and related components of the inline load sensor assembly of FIG. 17.

In this regard, the inline load sensor 205 shown in FIG. 17 in many respects is similar to the inline load sensor 160 shown in FIG. 10-16, except the inline load sensor 205 utilizes mechanical switch 225 to determine a load tension. The inline load sensor assembly 205 includes a main body 210 and corresponding side bodies 215, 220 that fit together either in a press fit, snap fit, or similar means to allow access the inside of the inline load sensor assembly 205 to facilitate removable attachment of the inline load sensor assembly 205 onto a line 40 of a tensioning assembly such as the tension assembly shown in FIG. 1.

One of the side bodies 220 may include guide posts 195, 200 to assist in guiding the side body 220 back into the main body 210 after removal of the side body 220 from the main body 210 to permit the line 40 of the tensioning assembly 5 to be inserting into the slot 185 of the rotatable spindle 180.

As shown in FIGS. 17 and 20, the inline load sensor assembly 205 further includes an on/off button 240, a PCB 120 having various electrical components, a battery 230 or similar type power source, switch contact points 235, and a rotatable spindle 180 having a slot, slit, or opening 185 formed therein for receiving the line 40.

A comparison between FIG. 18 and FIG. 19 shows a difference in positioning of the mechanical switch 225 and the tension in the line 40 in a non-tensioned state (FIG. 18), and the mechanical switch 225 and the tension of the line 40 in a tensioned state (FIG. 19). In this regard, when the line 40 is inserted into the inline load sensor assembly 205 and tension is applied to the line 40, the spindle 180 rotates the mechanical switch 225 so as to make contact with contact points 235. When the contact points 235 are contacted by the switch, the inline load sensor 205 is configured to determine a load tension and to communicate a signal representative of the load tension in a reliable, efficient, and precise manner.

As shown in the aforementioned figures, the various load sensor assemblies may be combined with an electronic interface of a smart device such as a tablet, phone, PDA, or similar device to signal or warn of a change in tension, either a loss or an increase in tension. The electronic interface may be enabled via blue tooth or other wireless technology and configured to communicate one of a programmed alert message, a sound or an alarm, activate a strobe or other beacon to another device to visually (LED) and audibly indicate a change in a defined parameter (tension imposed on the tensioning device). In this regard, the interface may provide a read out of a measure of strain imposed on the load. A loss of tension may be attributed to component level assembly failure, anchor point failure, or an unauthorized removal of tension. The electronic interface may include a miniature load cell with force gauge technology and a digital display to allow input of parameters.

As such, the subject matter disclosed herein provides for a load sensor assembly integrally formed with a tensioning assembly or alternatively to an inline load sensor assembly that is removably attachable to a line of a tensioning assembly thereby providing for a relatively more reliable, efficient, and precise determination of a load tension.

Although the method(s)/step(s) are illustrated and described herein as occurring in a certain order, the specific order, or any combination or interpretation of the order, is not required. Obvious modifications will make themselves apparent to those skilled in the art, all of which will not depart from the essence of the disclosed subject matter, and all such changes and modifications are intended to be encompassed within the appended claims.

What is claimed is:

1. A tensioning assembly comprising,
an integrally formed load sensor assembly for determination of a load tension.

2. The tensioning assembly of claim 1, wherein the integrally formed load sensor assembly includes a potentiometer or variable resistor for determination of the load tension.

3. The tensioning assembly of claim 1, wherein the integrally formed load sensor assembly includes wireless capability for communication of the determination of the load tension to another wireless device.

4. The tensioning assembly of claim 1, wherein the integrally formed load sensor assembly is configured to determine the load tension by converting an incremental mechanical rotational movement of the tensioning assembly into an electrical signal representative of the load tension incrementally from zero pounds to greater than a thousand pounds.

5. The tensioning assembly of claim 1, wherein the integrally formed load sensor determines one of a preset load tension limit, an incremental load tension, or a loss of a load tension.

6. The tensioning assembly of claim 1, wherein the tensioning assembly is one of ratchet assembly or a cam buckle assembly.

7. The tensioning assembly of claim 6, wherein the one of the ratchet assembly or the cam buckle assembly is one of a ratchet buckle, turn-buckle, over-center buckle, or a winch.

8. A removably attachable load sensor assembly comprising,
a frame structure:
a first line connected to the frame structure; and
a second line connected to a tensioning assembly,
wherein connection of the first line and the second attaches the load sensor to the tensioning assembly to determine a load tension.

9. The removably attachable load sensor assembly of claim 8, wherein the load sensor assembly includes a potentiometer or variable resistor for determination of the load tension.

10. The removably attachable load sensor assembly of claim 8, wherein the load sensor assembly includes wireless capability for communication of the determination of the load tension to another wireless device.

11. The removably attachable load sensor assembly of claim 8, wherein the load sensor assembly is configured to determine the load tension by converting an incremental mechanical rotational movement of the tensioning assembly into an electrical signal representative of the load tension incrementally from zero pounds to greater than a thousand pounds.

12. The removably attachable load sensor assembly of claim 8, wherein the load sensor determines one of a preset load tension limit, an incremental load tension, or a loss of a load tension

13. The removably attachable load sensor assembly of claim 8, wherein the tensioning assembly is one of ratchet assembly or a cam buckle assembly.

14. The removably attachable load sensor assembly of claim 13, wherein the one of the ratchet assembly or the cam buckle assembly is one of a ratchet buckle, turn-buckle, over-center buckle, or a winch.

15. An inline load sensor assembly removably attachable to a line of a tensioning assembly to determine a load tension developed by the tensioning assembly.

16. The inline load sensor assembly of claim 15, wherein the load sensor assembly includes a potentiometer or variable resistor for determination of the load tension.

17. The inline load sensor assembly of claim 15, wherein the load sensor assembly includes wireless capability for communication of the determination of the load tension to another wireless device.

18. The inline load sensor assembly of claim 15, wherein the load sensor assembly is configured to determine the load tension by converting an incremental mechanical rotational movement of the tensioning assembly into an electrical signal representative of the load tension incrementally from zero pounds to greater than a thousand pounds.

19. The inline load sensor assembly of claim 15, wherein the load sensor determines one of a preset load tension limit, an incremental load tension, or a loss of a load tension

20. The inline load sensor assembly of claim 15, wherein the tensioning assembly is one of ratchet assembly or a cam buckle assembly.
